(19) United States
(12) Patent Application Publication
(10) Pub. No.: US 2012/0222265 A1
(43) Pub. Date: Sep. 6, 2012

(54) BAR END PLUG OF HANDLE GRIP

(76) Inventor: CHIH-HSIEN CHEN, TAICHUNG CITY (TW)

(21) Appl. No.: 13/040,408

(22) Filed: Mar. 4, 2011

(51) Int. Cl. F16C 33/04

(52) U.S. Cl. 16/2.2

(57) ABSTRACT

A bar end plug structure of handle grip has an assembly aperture formed on its plug main body. A gap is provided on one side of the plug main body and a fastening unit is provided on the lateral of the gap. The structure further has a plug cap and a flexible washer. The flexible washer has a housing aperture to be engaged by an annular block of the plug cap. The flexible washer is invaginated into one side of the assembly aperture of the plug main body, while a grip is inserted in the other side of the same. Thus, the flexible washer is used as a cushion among the plug main body, the plug cap and the grip to compensate relative tolerance occurred among them during manufacturing, so as to firmly assemble them together, furthermore, to maintain their respective structure in good integrity without damage happened.

### BACKGROUND OF THE INVENTION

1. Field of the Invention

The present invention relates to a bar end plug structure of handle grip, more particularly to a bar end plug structure enabling the plug main body, the plug cap and the grip to be assembled in firm manner and the structure after assembly to be maintained in good integrity.

2. Brief Description of Prior Art

In order that users can firmly grasp handles of motorcycle, bicycle, racket or hand tool, grips are usually assembled on the handles thereof so as to produce sliding-proof effect for users to grasp firmly. At the same time, decorative design or patterns provided on the grip can further enhance aesthetics and dazzling effect of the handle. After the grip is assembled on the handle, a bar end plug is usually assembled on the end portion of the grip so as to avoid permeation or attachment of water, foreign matters between the handle and grip of motorcycle, bicycle, racket or hand tool.

Conventional bar end plug structure of handle grip is composed of a plug main body and a plug cap, in which an assembly aperture is formed on the plug main body. A gap extending to communicate with the assembly aperture is provided on one side of the plug main body. One end of the assembly aperture is inserted into grip. On the other hand, an annular block is provided on the end portion of the plug cap for inserting in the other end of the assembly aperture. Subsequently, a bolt is threaded into a tapped hole going through a gap groove of the plug cap so as to constrict the gap groove and the assembly aperture of the plug main body and to tighten the constricted assembly aperture. In this way, the plug main body can hold the grip and the plug cap firmly together.

However, as relative tolerance is easily produced between the annular block and the grip according to this design, the annular block and the grip often failed to be firmly tightened at the same time by the assembly aperture of the plug main body, hence one side of the annular block and the grip becomes loosened. In this condition, if the assembly aperture is imposed to be constricted so as to tighten the plug main body and the plug cap and the grip to lock at the same time. Any one of the plug main body, the plug cap and the grip might be damaged, if they are all made of metallic hard materials.

In view of the above disadvantages occurred in the assembly of conventional bar end plug structure of handle grip, the inventor of the present invention conducts research and development to improve conventional bar end plug structure of handle grip according to his abundant experience of R&D and manufacturing in relevant field and skillful contemplation in many ways, so as to achieve better performance value in practical application.

### SUMMARY OF INVENTION

This invention relates to a bar end plug structure of handle grip, the main object is to provide a bar end plug structure enabling the plug main body, the plug cap and the grip to be assembled in firm manner and the structure after assembly to be maintained in good integrity.

In order to achieve above implementation object, the inventor of the present invention hereby presents the novel technical means described as below. An assembly aperture is formed on its plug main body. A gap is provided on one side of the plug main body and a fastening unit is provided on the lateral of the gap. The structure further has a plug cap and a flexible washer. The flexible washer has a housing aperture to be inserted by an annular block of the plug cap. In turn, the flexible washer is invaginated into one side of the assembly aperture of the plug main body, while a grip is inserted in the other side of the same.

Thus, the flexible washer is used as a cushion among the plug main body, the plug cap and the grip to compensate relative tolerance occurred among them during processing and manufacturing, so as to assemble the plug main body, the plug cap and the grip in firm manner, furthermore, to maintain their respective structure in good integrity without damage happened.

Furthermore, an engaging piece is formed on the circumferential edge of the flexible washer for engaging with the gap of the plug main body. At least one engaging projection is provided on the peripheral wall of the housing aperture for engaging with at least one breach provided on the circumferential wall of the annular block of the plug cap. In this way, there is neither rotation nor sliding happened between the plug main body and the plug cap after assembly, so as to enhance steadiness after assembly.

Moreover in the bar end plug of handle grip of the present invention, a light emitting unit is mounted on the end face of the plug cap so as to enhance alarm, illumination or entertainment effect of motorcycle, bicycle or hand tool to which the light emitting unit is attached. Accordingly, implementation benefits of the present invention are raised.

### BRIEF DESCRIPTION OF THE DRAWINGS

FIG. 1 is a perspective exploded view showing the present invention.

FIG. 2 shows the assembly process of the present invention.

FIG. 3 is a front sectional view of the present invention.

FIG. 4 is a side sectional view of the present invention.

FIG. 5 is a perspective view of the present invention.

FIG. 6 is a front sectional view of another embodiment of the present invention.

### DETAILED DESCRIPTION OF PREFERRED EMBODIMENT

The objects, the technical contents and the expected effectiveness of the present invention will become more apparent from the detailed description of the preferred embodiment in conjunction with the accompanying drawings.

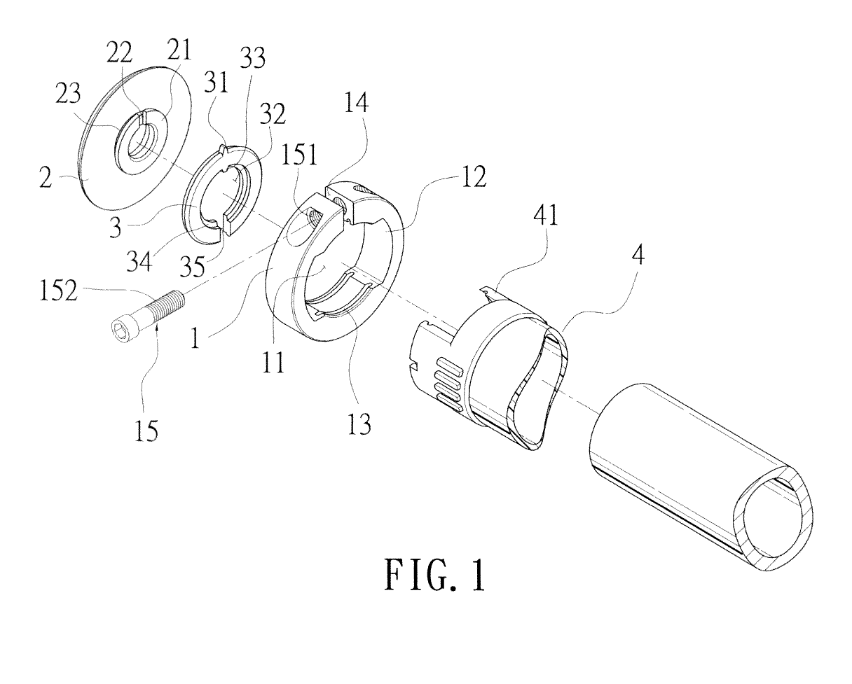

Firstly referring to FIG. 1, the bar end plug of the present invention comprises a plug main body (1), a plug cap (2) and a flexible washer (3).

The plug main body (1) has an assembly aperture (11), two positioning recesses (12) opposite to each other being formed on two sides of the assembly aperture (11), two grooves (13) being respectively formed near the end edges of the inner wall of the assembly aperture (11). A gap (14) is formed on one side of the plug main body (1), which is extended to communicate with the assembly aperture (11) of the plug main body (1). A fastening unit (15) is provided on the lateral of the gap (14) of the plug main body (1), which includes tapped holes (151) provided on both sides of the gap and a bolt (152) engaged in the tapped holes (151).

The plug cap (2) is assembled to one end of the plug main body (1), and the plug cap (2) has an annular block (21) provided on the end confronting the plug main body (1), at least one breach (22) for engaging purpose is formed on the annular block (21). Further, a ditch (3) is formed on the bottom edge of the annular block (21).

The flexible washer (3) is a plastic sheet having flexibility, which is invaginated in the assembly aperture (11) of the plug main body (1) and is inserted into the groove (13) provided on any one end edge of the inner wall of the assembly aperture (11). An engaging piece (31) is formed on the circumferential edge of the flexible washer (3) for engaging with the gap (14) of the plug main body (1). Further, a housing aperture (32) is provided on the flexible washer (3) to be inserted by the annular block (21) of the plug cap (2). Furthermore, at least one engaging projection (33) is provided on the peripheral wall of the housing aperture (32) for engaging with the breach (22) provided on the circumferential wall of the annular block (21). A protruding rim (34) is formed on the bottom edge of the housing aperture (32) of the flexible washer (3), which is engaged in the ditch (23) formed on the bottom edge of the annular block (21). Moreover, a notch (35) is formed on one side of the flexible washer (3), which is extended to communicate with the housing aperture (32).

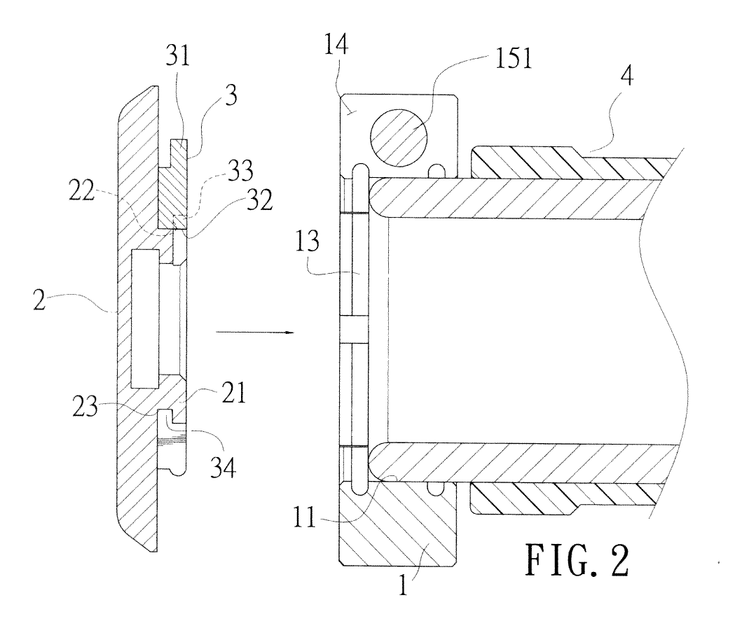

Configuring in this manner, the assembly process will be described in reference to FIG. 2. The housing aperture (32) of the flexible washer ( )is firmly engaged with the annular block (21) of the plug cap (2) by inserting the protruding rim (34) provided on the bottom edge of the housing aperture (32) firmly into the ditch (23) provided on the annular block (21), and the engaging projection (33) provided on the peripheral wall of the housing aperture (32) of the flexible washer (3) is engaged with the breach (22) provided on the circumferential wall of the annular block (21).

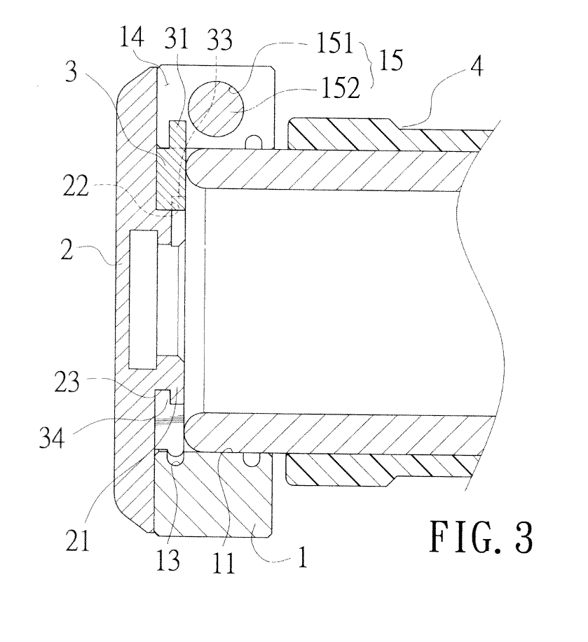

Further referring to FIG. 3, the plug cap (2) combined with the flexible washer (3) thereon is assembled with the plug main body (1) in such a manner that the flexible washer (3) is inserted in any one side of the assembly aperture (11). In this manner, the flexible washer (3) is engaged and positioned in the groove (13) on the wall of the assembly aperture (11), and the engaging piece (31) on the circumferential edge of the flexible washer (3) is engaged with the gap (14) of the plug main body (1). Configuring like this, the plug main body (1) and the plug cap (2) and the flexible washer (3) can reach immobility effect by the engagings reached between the gap (14) and the engaging piece (31), and between the breach (22) and the engaging projection (33).

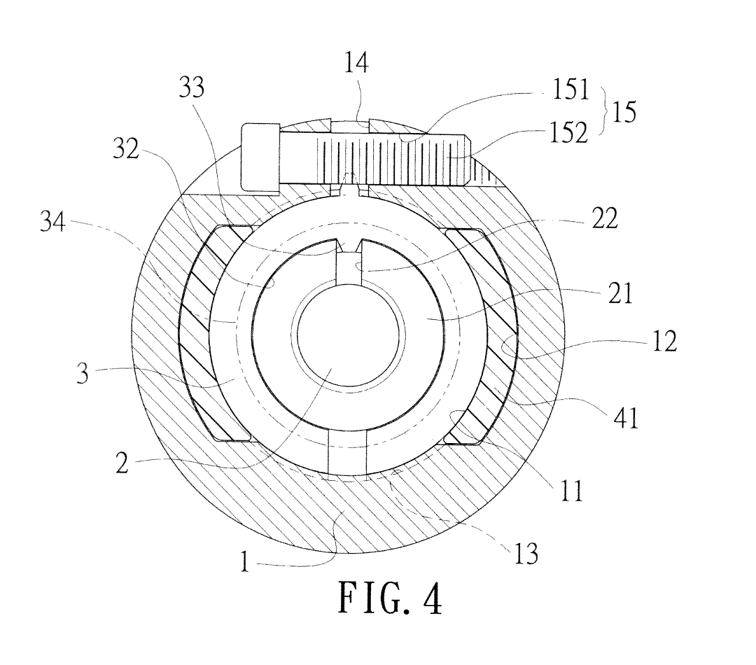

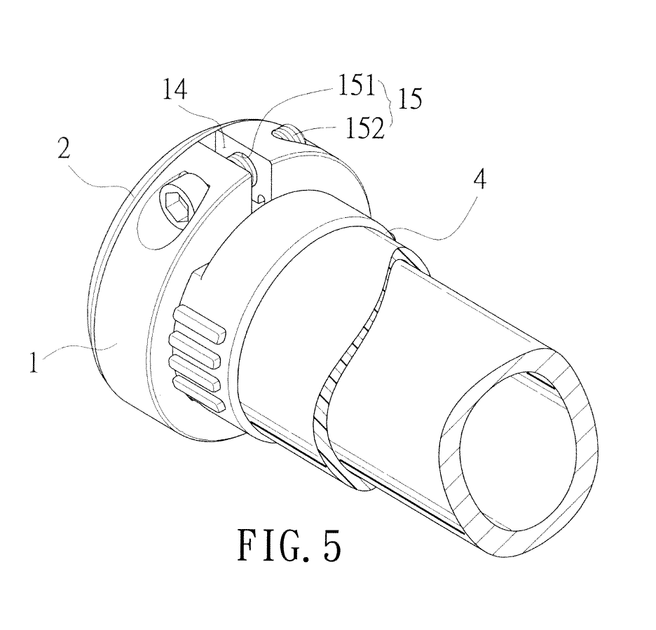

Further referring to FIG. 4, one end of a grip (4) pre-assembled on the handle of motorcycle, bicycle, racket or hand tool is invaginated into another side of the assembly aperture (11) of the plug main body (1), in which two protruding sections (41) provided on this one end of the grip (4) are fitted in the positioning recesses (12) of the assembly aperture (11). In turn, the bolt (152) is threaded into the tapped holes (151) of the plug main body (1) to constrict the gap (14) and hence the size of the assembly aperture (11) so that the flexible washer (3) attached to the assembly aperture (11) of the plug main body (1) and the grip (4) are tightened in firm manner to lock. In this way, the assembly is thus accomplished as shown in FIG. 5.

As the flexible washer (3) of the present invention is a plastic sheet having flexibility, appropriate stretching or shrinking of the flexible washer (3) is allowed depending on the condition of the grip (4) so that the grip (4) and the plug cap (2) having the flexible washer (3) attached herewith can be assembled integrally with plug main body (1) in firm manner, without being affected by the relative tolerance occurred in the manufacturing process. In the case of relative tolerance occurred in conventional structure, one side may becomes loosened so that the plug main body (1), the plug cap (2) or the grip (4) may be damaged when tightened to lock. While in the case of the present invention, not only firm assembly among the plug main body (1), the plug cap (2) or the grip (4) can be achieved but also the plug main body (1), the plug cap (2) or the grip (4) can be kept in integrity and good condition.

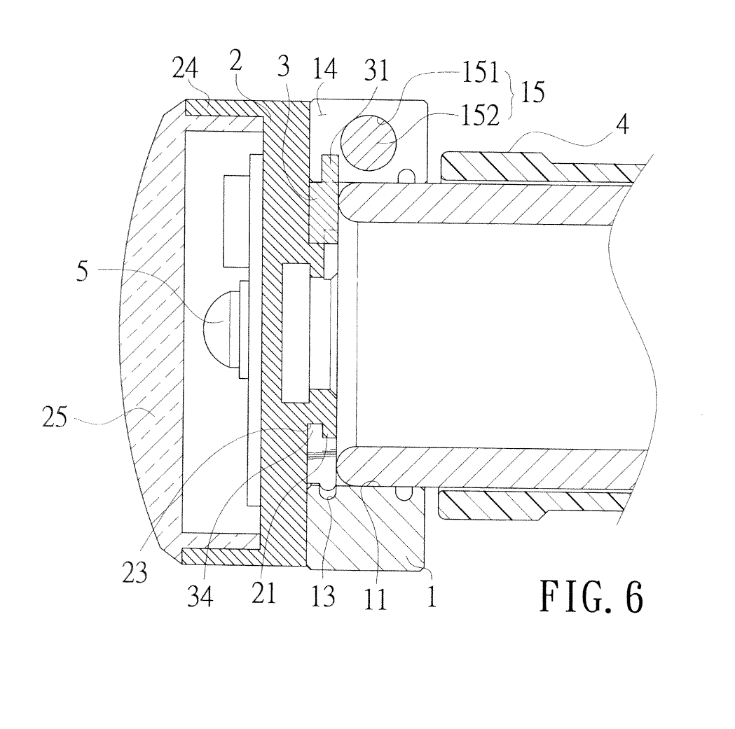

Further referring to another embodiment shown in FIG. 6, a light emitting unit (5) is assembled on the other end face of the plug cap opposite to the annular block (21), and a condenser wall (24) is formed on the surrounding of the light emitting unit (5). Correspondingly, a lamp shade (25) is provided on the end portion of the condenser wall (24) so as to cap the light emitting unit (5). Configuring like this, when at night or when light is dim, turning-on of the light emitting unit (5) can provided alarming function according to the mounting position of the light emitting unit (5) on the handles of motorcycle and bicycle. If the light emitting unit (5) is mounted on the handle of the hand tool, illumination effect during operation of hand tool under dim light condition can be obtained. If the light emitting unit (5) is mounted on the grip of racket, dazzling effect can be obtained when waving the racket. In this manner, safety of driving, convenience of operation and entertainment of playing ball can be increased respectively.

Based on foregoing, apparently this invention has advantages set forth below.

1. The bar end plug of handle grip uses a flexible washer as a cushion element among the plug main body, the plug cap and the grip. Relative tolerance between the grip and the annular block of the plug cap occurred in the processing and manufacturing can be compensated by the flexibility of the flexible washer, so that the plug main body, the plug cap and the grip can be firmly assembled together, and their respective structure can be maintained in good integrity without damage happened.

2. In the bar end plug of handle grip of the present invention, an engaging piece is formed on the circumferential edge of the flexible washer to engage with a gap of the plug main body. Furthermore, at least one engaging projection is provided on the peripheral wall of the housing aperture to engage with the breach provided on the circumferential wall of the annular block. In this way, there is neither rotation nor sliding happened between the plug main body and the plug cap after assembly, so that steadiness after assembly can be ensured.

3. In the bar end plug of handle grip of the present invention, a light emitting unit is mounted on the end face of the plug cap so as to enhance alarm, illumination or entertainment effect of motorcycle, bicycle or hand tool to which the light emitting unit is attached. Accordingly, implementation benefits of the present invention are raised.

Summing up above, the above embodiments of this invention can achieve expected effects, and the specific structure disclosed herein has been unprecedented in the same category of product, even has not been opened to the public before application.

What is claimed is:

1. A bar end plug, comprising:
a plug main body (1), having an assembly aperture (11) formed thereon and a gap (14) provided on one side thereof, said gap (14) being extended to communicate with said assembly aperture (11), a fastening unit (15) being provided on the lateral of said gap (14),
a plug cap (2) having an annular block (21) formed on one end thereof, and
a flexible washer (3) having a housing aperture (32) to be inserted by said annular block (21) of said plug cap (2), said flexible washer (3) being further invaginated into said assembly aperture (11) of said plug main body (1).

2. A bar end plug as claimed in claim 1, wherein an engaging piece (31) is further formed on the circumferential edge of said flexible washer (3) for engaging with said gap (14) of said plug main body (1); at least one engaging projection (33) being provided on the peripheral wall of said housing aperture (32) for engaging with at least one breach (22) provided on the circumferential wall of said annular block (21) of said plug cap (2).

3. A bar end plug as claimed in claim 2, wherein said plug cap (2) further has a light emitting unit (5) assembled on the other end face opposite to said annular block (21).

4. A bar end plug as claimed in claim 3, wherein said plug cap (2) further has a condenser wall (24) formed on the other end face opposite to said annular block (21) and encircling said light emitting unit (5), a lamp shade (25) being further provided on the end portion of said condenser wall (24).

5. A bar end plug as claimed in claim 1, wherein a ditch (23) is formed on the bottom edge of said annular block (21) and a protruding rim (34) is formed on the bottom edge of said housing aperture (32) of said flexible washer (3) to engage with said ditch (23) formed on said plug cap (2).

6. A bar end plug as claimed in claim 1, wherein said plug cap (2) further has a light emitting unit (5) assembled on the other end face opposite to said annular block (21).

7. A bar end plug as claimed in claim 6, wherein said plug cap (2) further has a condenser wall (24) formed on the other end face opposite to said annular block (21) and encircling said light emitting unit (5), a lamp shade (25) being further provided on the end portion of said condenser wall (24).

8. A bar end plug as claimed in claim 1, wherein a notch (35) is formed on one side of said flexible washer (3) and is extended to communicate with said housing aperture (32).

9. A bar end plug as claimed in claim 1, wherein two grooves (13) are respectively formed on the wall end edges of the assembly aperture (11), said flexible washer (3) being engaged in anyone of said grooves (13).

10. A bar end plug as claimed in claim 1, wherein said fastening unit (15) of said plug main body (1) includes tapped holes (151) provided on both sides of the gap and a bolt (152) engaged in the tapped holes (151).
